(19) United States
(12) Patent Application Publication
(10) Pub. No.: US 2014/0335242 A1
(43) Pub. Date: Nov. 13, 2014

(54) AUTOMATIC COCKTAIL MACHINE AND METHOD

(71) Applicant: HSIANG-CHI HUANG, New Taipei City (TW)

(72) Inventor: HSIANG-CHI HUANG, New Taipei City (TW)

(21) Appl. No.: 13/892,326

(22) Filed: May 13, 2013

(51) Int. Cl. C12G 3/04

(52) U.S. Cl. CPC C12G 3/04
USPC 426/231; 99/277; 62/331

(57) ABSTRACT

Disclosed are an automatic cocktail machine and an automatic cocktail making method. Water, a carbonic acid gas cylinder and a plurality of cocktail materials are inputted. After a user's cocktail request is received, the cocktail request is compared with a list to determine the requested cocktail and read the cocktail recipe correspondingly. A bartending module is provided for adjusting and mixing water and the carbonic acid gas according to the cocktail recipe to form a carbonated water, and adjusted to a recipe temperature. An output module is provided for mixing an appropriate quantity of cocktail materials with the carbonic acid gas cylinder to output the cocktail. With this simple and convenient automatic cocktail machine, the users can get various cocktails quickly and enjoy different delicious cocktails.

### BACKGROUND OF THE INVENTION

1. Field of the Invention

The present invention relates to the technical field of automatic beverage making equipments, and more particularly to the automatic cocktail machine and method applicable in restaurants, bars or high-end consumer groups to provide users delicious alcoholic drinks, save the trouble of mixing the drinks manually, and avoid poor taste caused by inaccurate ingredients of the drinks.

2. Description of the Related Art

To pursuit excellent tastes, ancient Egyptians added honey or date-plum juice in beer for drinks, and ancient Greeks and Romans added fruit juices into wines or seawater to dilute a drink. Till the seventies and eighties of the 19^{th} Century, fancy drinks with the sexy name “Disco Drink” such as Sex on the Beach and Screaming Orgasm made by mixing various types of fruit juices and having exaggerated colorful decorations became very popular in social circles of Britain and the United States. Drinks mixed with different types of alcohols to pursue rich aroma, favor, and taste are now called “Cocktails”. In addition, the cocktails usually come with a mild taste easily acceptable to everyone for any occasion anytime and anywhere, and thus the cocktails can be seen almost everywhere for different events or leisure activities. For example, champagne cocktails are often listed in the menus for parties to enhance the relaxed and pleasant atmosphere; classic cocktails are served in business meetings to highlight the participants' temperament; and simple Collins or punches are served in family gatherings to make the gatherings more fun and enjoyable. Therefore, cocktails are not drinks only, but also refer to a culture and an attitude, and a general user can causally and manually make a cocktail for oneself and others. However, the general users usually cannot control the proportion of the ingredients precisely, and thus affecting the taste of the drinks, failing to meet the users' or relatives' requirements and satisfaction, and leaving a regret that the expectation cannot be fulfilled.

To overcome the aforementioned problem, it is a subject for related manufacturers to provide a beverage maker capable of preparing cocktails automatically and allow users to select an alcoholic beverage with good taste and temperature from a menu easily and improve the life quality and satisfaction.

### SUMMARY OF THE INVENTION

In view of the problems of the prior art, it is a primary objective of the present invention to provide an automatic cocktail machine and an automatic cocktail making method with a simple operation, and control the ingredients, temperature and preparation time of a cocktail precisely through the setting of a software program to automatically produce a beverage with perfect quality, so as to satisfy the users' taste buds and improve life quality and satisfaction.

To achieve the aforementioned objective, the present invention provides an automatic cocktail machine comprising a raw material module, a processing module, a bartending module and an output module, wherein the raw material module is provided for containing water, a carbonic acid gas cylinder having carbonic acid gas and a plurality of cocktail materials and automatically making a plurality of delicious cocktails. The processing module includes a plurality of cocktail recipes stored therein, and the bartending module is electrically coupled to the raw material modules and the processing module, and the output module is electrically coupled to the raw material modules and the processing module and connected to the bartending module. The automatic cocktail making method comprises the steps of: inputting water, carbonic acid gas and a plurality of cocktail materials; receiving a cocktail request, and then comparing the cocktail request with a list to obtain the type of the requested cocktail to read a corresponding cocktail recipe; adjusting the quantity of water and carbonic acid gas according to the cocktail recipe, mixing the water and carbonic acid gas form a carbonated water according to a recipe proportion of the cocktail recipe, and adjusting the carbonated water to a recipe temperature; and adjusting the quantity of the cocktail materials according to the cocktail recipe, and then mixing the cocktail materials with the carbonated water at the recipe temperature to output the cocktail.

Wherein, the cocktail materials and the carbonated water are shaken at a predetermined shaking speed when the cocktail is mixed and outputted. The raw material module includes a water tank, a gas cylinder slot and a plurality of raw material tanks coupled to the bartending module or the output module through a corresponding duct. The bartending module includes a bartending tank and a cooler, and the bartending tank is connected to the water tank and the gas cylinder slot through the ducts for mixing the carbonated water, and then the temperature of the carbonated water is adjusted to the recipe temperature by the cooler. In addition, the automatic cocktail machine further comprises an ice making module electrically coupled to the processing module and connected to the output module, such that when the processing module receives an ice-adding request to output an ice making instruction, the ice making module outputs a plurality of ice cubes of a corresponding quantity to the output module according to the ice making instruction, and the output module shakes and mixes the cocktail materials, the carbonated water and the ice cubes to output the cocktail.

To provide a variety of drinks flexibly, the processing module has a detachable storage medium connected point-to-point with an electronic device or a network connected to a terminal server database to download and update the cocktail recipe, so as to provide the users different choices of drinks from a diversified menu and meet the actual requirements.

In summation, the present invention provides a simple and handy cocktail machine provided for restaurants or bars as well as personal use at home, and users can just press the buttons to obtain and enjoy various delicious cocktails such as Mojito, Singapore Sling, Cosmopolitan, Mai Tai, Long Island Iced Tea, and Whisky Sour, so as to assist the users to have a high-quality, elegant and fashionable life style.

### BRIEF DESCRIPTION OF THE DRAWINGS

FIG. 1 is a block diagram of a cocktail machine of a first preferred embodiment of the present invention;

FIG. 2 is a flow chart of a cocktail making method of the first preferred embodiment of the present invention;

FIG. 3 is a block diagram of a cocktail machine of a second preferred embodiment of the present invention;

FIG. 4 is a flow chart of a cocktail machine of the second preferred embodiment of the present invention; and

FIG. 5 is a schematic view of a cocktail making method of the second preferred embodiment of the present invention.

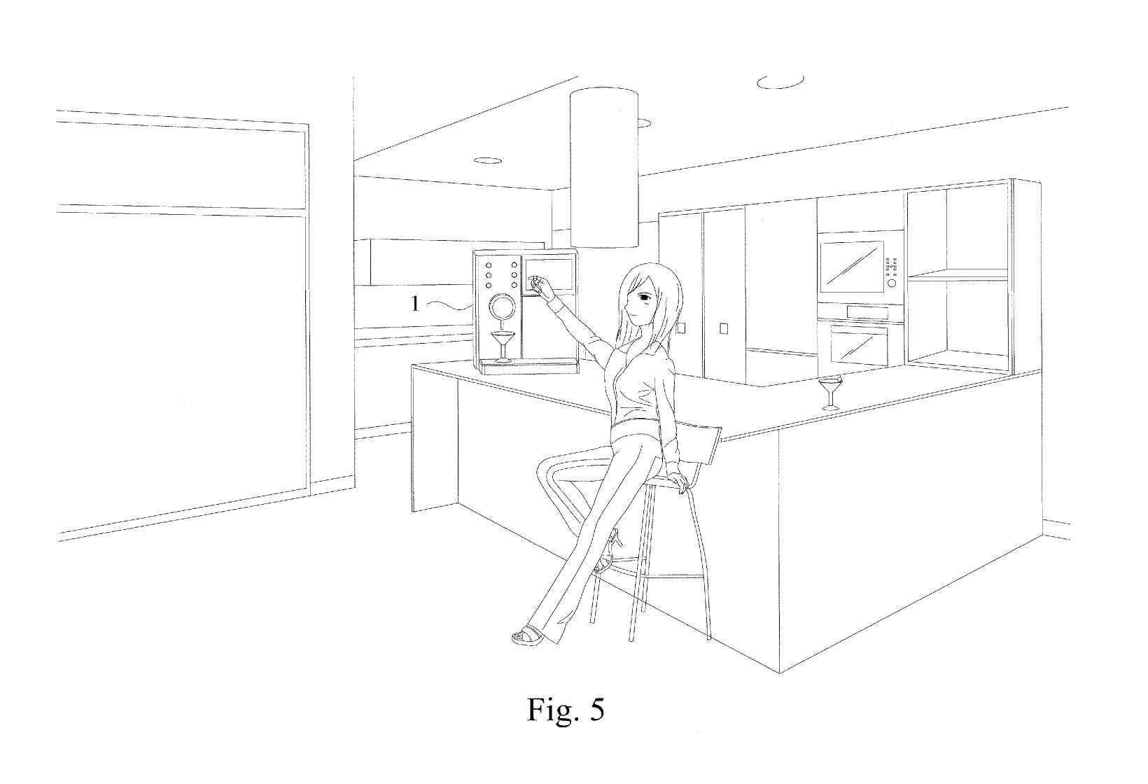

### DETAILED DESCRIPTION OF THE PREFERRED EMBODIMENTS

The technical content of the present invention will become apparent with the detailed description of preferred embodiments and the illustration of related drawings as follows.

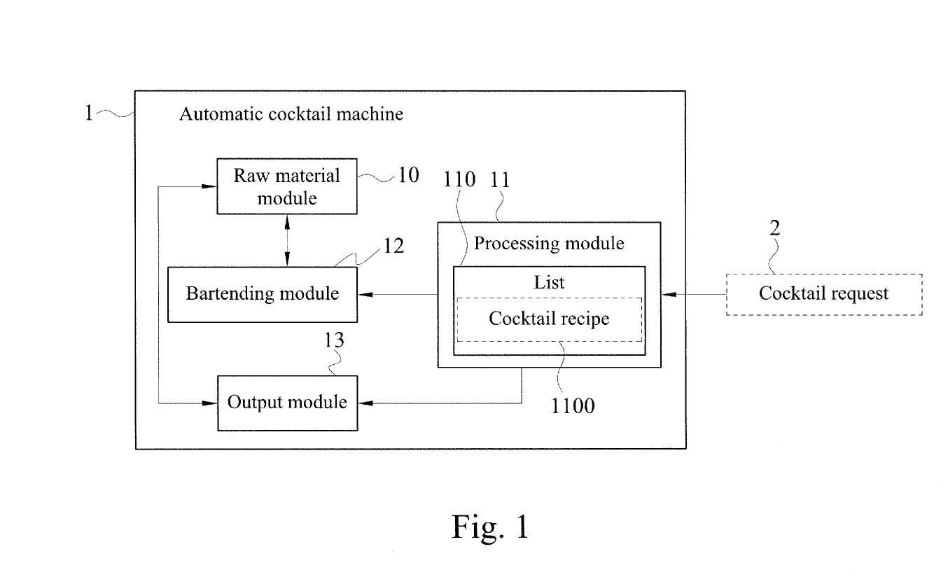

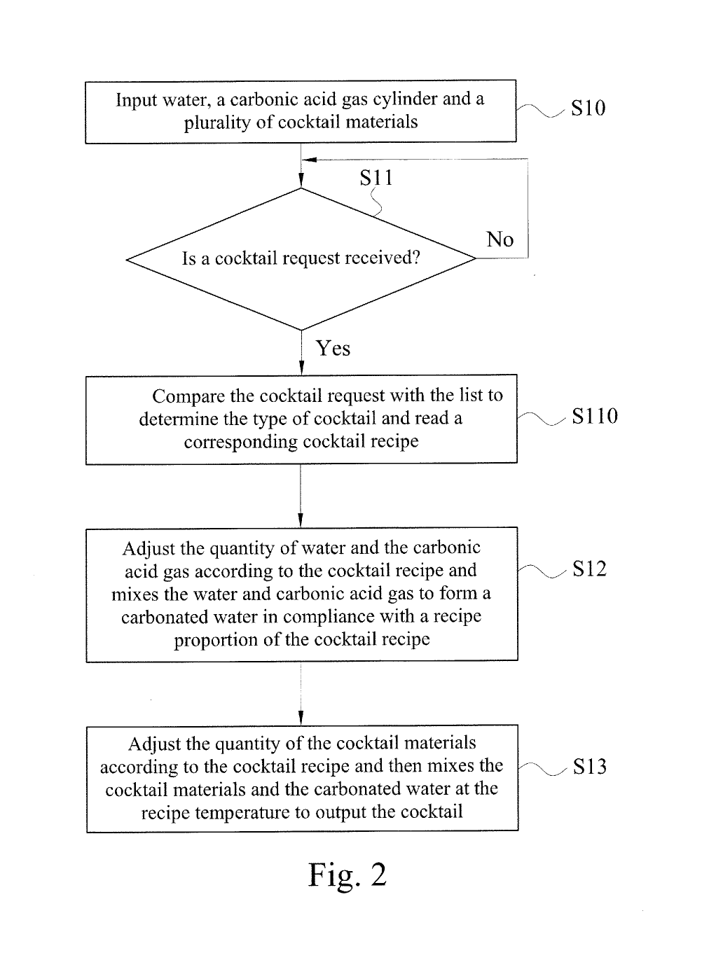

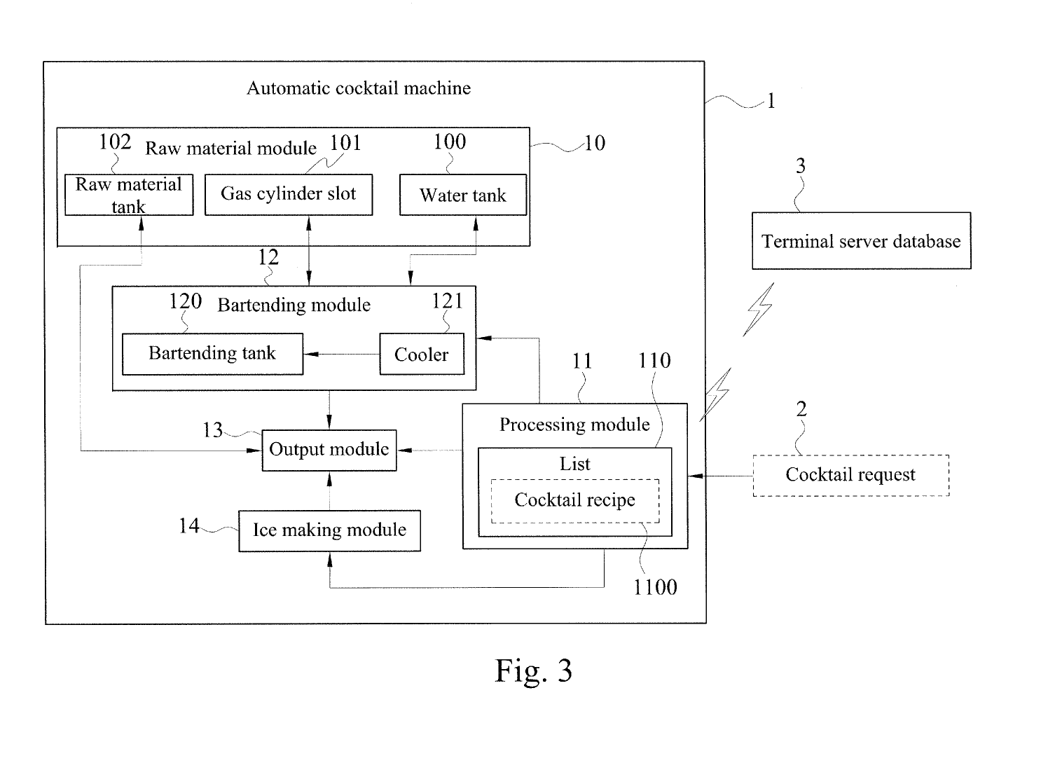

With reference to FIGS. 1 to 3 for a block diagram of a cocktail machine, a flow chart of a cocktail making method, and a block diagram of a cocktail machine in accordance with the first preferred embodiment of the present invention respectively, an automatic cocktail machine 1 has the function of automatically making a plurality of delicious cocktails provided for restaurants or bars to lower the labor cost and increase the speed of serving, or provided for high-end consumer groups to satisfy their life quality and fully enjoy life. The automatic cocktail machine 1 comprises a raw material module 10, a processing module 11, a bartending module 12, an output module 13 and an ice making module 14, wherein the raw material module 10 includes a water tank 100, a gas cylinder slot 101 and a plurality of raw material tanks 102 for containing water, a carbonic acid gas cylinder and a plurality of cocktail materials respectively, and the bartending module 12 includes a bartending tank 120 and a cooler 121. The bartending tank 120 is connected to the cooler 121 and also connected to the water tank 100 and the gas cylinder slot 101 through a duct, and the raw material tanks 102 are connected to the output module 13 through a duct, and the ducts have a valve installed separately at the bartending module 12 and the output module 13. The processing module 11 contains a plurality of cocktail recipes 110 and is electrically coupled to the bartending module 12, the output module 13 and the ice making module 14, wherein the cocktail recipes 1100 are classified and listed in a list 110. The bartending module 12 is electrically coupled to the corresponding valve and connected to the output module 13, and the output module 13 is electrically coupled to the corresponding valve and connected to the ice making module 14. The operation of the automatic cocktail machine 1 comprises the following steps.

Firstly, a user checks whether or not raw materials are prepared. In Step S10, water, a carbonic acid gas cylinder and a plurality of cocktail materials are put into the water tank 100, the gas cylinder slot 101 and the raw material tanks 102 respectively. After the user turns on the power and select a menu option from a panel of the automatic cocktail machine 1. In Step S11, the processing module 11 determines whether or not a cocktail request 2 is received. In Step S110, the cocktail request 2 is compared with the list 110 to determine the type of cocktail and read a corresponding cocktail recipe 1100 if the processing module 11 has received the cocktail request 2, and then the cocktail recipe 1100 is sent to the bartending module 12 and the output module 13. In Step S12, the bartending module 12 controls the valves to adjust the quantity of water and carbonic acid gas according to the cocktail recipe 1100 and mixes the water and carbonic acid gas to form a carbonated water in compliance with a recipe proportion, and adjusts the carbonated water to a recipe temperature. In Step S13, the output module 13 controls the valves to adjust the quantity of the cocktail materials according to the cocktail recipe 1100 and then mixes the cocktail materials and the carbonated water at the recipe temperature to output the cocktail.

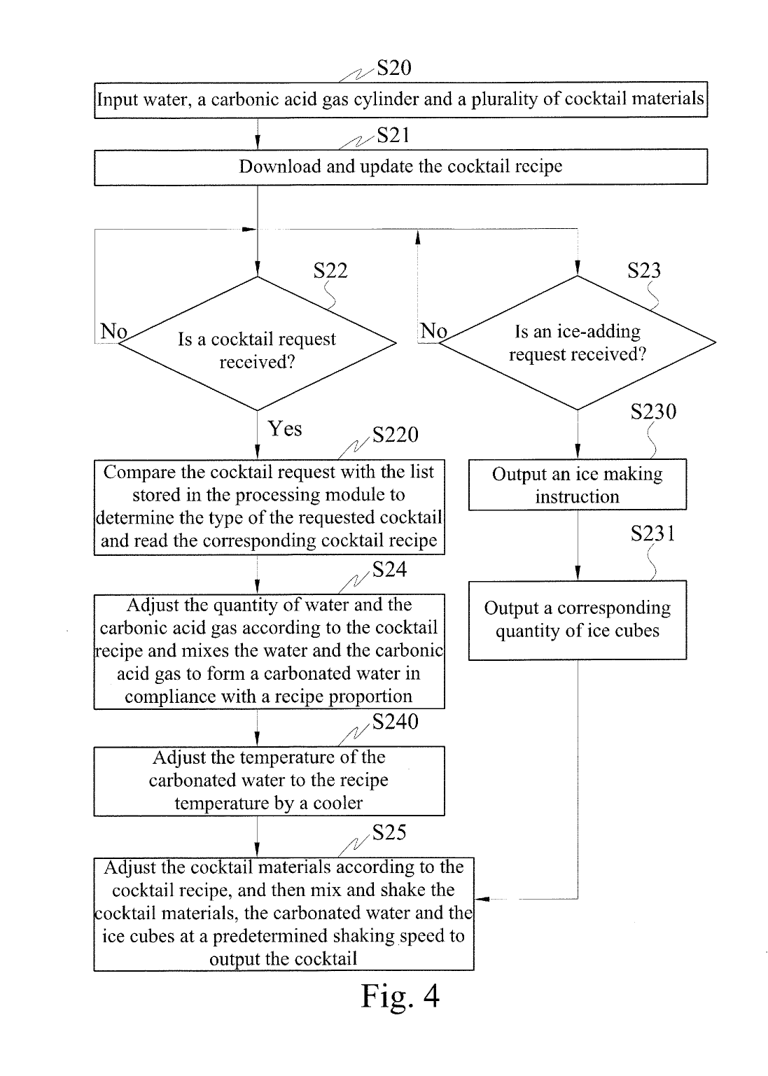

It is noteworthy that the processing module 11 as shown in FIG. 4 checks and supplements water, carbonic acid gas and cocktail materials to the water tank 100, gas cylinder slot 101 and raw material tanks 102 respectively as shown in Step S20. In Step S21, a detachable storage medium is provided and connected point-to-point with an electronic device such as a mobile phone or a table PC through a connection line or connected to a terminal server database 3 via a network to download and update the cocktail recipes 1100 and expand the menu options to satisfy the requirements for diversified beverages, and users also can login a terminal server webpage to edit the cocktail recipes 1100 and improve the level of customization to meet the different users' preference and enhance the product satisfaction significantly.

In Step S22, the processing module 11 continues determining whether or not the cocktail request 2 is received and waits for the user to select a cocktail from the menu option and issue a bartending instruction. In Step S220, the processing module 11 compares the cocktail request 2 with the list 110 stored in the processing module 11 to determine the type of the requested cocktail and reads the corresponding cocktail recipe 1100 such as the menu of Mojito, Singapore Sling, Cosmopolitan, Mai Tai, Long Island Iced Tea or Whisky Sour, and then sends the cocktail recipe 1100 to the bartending module 12 and the output module 13. An ice-adding button is provided in the menu option for users to select according to their preference. In the meantime, if the user presses the ice-adding button, the processing module 11 will determine whether or not an ice-adding request is received in Step S23. In Step S230, if the ice-adding request is received, the processing module 11 outputs an ice making instruction according to the ice-adding request to drive the ice making module 14 to execute the Step S231. In Step 231, a corresponding quantity of ice cubes is outputted to the output module 13 according to the ice making instruction. In Step S24, the bartending module 12 controls the valves to receive an appropriate quantity of water and carbonic acid gas from the water tank 100 and the gas cylinder slot 101 according to the cocktail recipe 1100 and then mixes the water and carbonic acid gas to form the carbonated water in compliance with a recipe proportion. In Step S240, the cooler 121 is provided for adjusting the carbonated water to the recipe temperature. In Step S25, the output module 13 controls the valves to receive an appropriate quantity of the cocktail materials from the raw material tanks 102 according to the cocktail recipe 1100, and then mixes and shakes the cocktail materials, the carbonic acid gas cylinder and the ice cubes at a predetermined shaking speed to output the cocktail.

What is claimed is:

1. An automatic cocktail machine, for making a plurality of cocktails, comprising:
a raw material module, containing water, a carbonic acid gas cylinder having carbonic acid gas, and a plurality of cocktail materials;
a processing module, including a plurality of cocktail recipes stored therein, and comparing a cocktail request with a list to find out and output the cocktail recipe corresponding to the cocktail request, after the processing module receives the cocktail request;
a bartending module, electrically coupled to the raw material modules and the processing module, for regulating a quantity of the water and the carbonic acid gas outputted from the raw material module, mixing the water and the carbonic acid gas to form a carbonated water according to a recipe proportion of the cocktail recipe, and adjusting the carbonated water to a recipe temperature, after the bartending module receives the cocktail recipe; and
an output module, electrically coupled to the raw material module and the processing module, and connected to the bartending module, for regulating the quantity of the cocktail materials outputted from the raw material module according to the cocktail recipe, and the bartending module receiving the carbonated water at the recipe temperature, and then mixing the cocktail materials and the carbonated water to output the cocktail.

2. The automatic cocktail machine of claim 1, wherein the output module shakes and mixes the cocktail materials and the carbonated water at a predetermined shaking speed.

3. The automatic cocktail machine of claim 1, wherein the raw material module include a water tank, a gas cylinder slot and a plurality of raw material tanks coupled to the bartending module or the output module through a corresponding duct.

4. The automatic cocktail machine of claim 3, wherein the bartending module includes a bartending tank and a cooler, and the bartending tank is connected to the water tank and the gas cylinder slot through the corresponding ducts for mixing the carbonated water, and then the temperature of the carbonated water is adjusted to the recipe temperature by the cooler.

5. The automatic cocktail machine of claim 1, further comprising an ice making module, electrically coupled to the processing module, and connected to the output module, such that when the processing module receives an ice-adding request to output an ice making instruction, the ice making module outputs a corresponding quantity of a plurality of ice cubes according to the ice making instruction to the output module, and the output module shakes and mixes the cocktail materials, the carbonated water and the ice cubes to output the cocktail.

6. The automatic cocktail machine of claim 1, wherein the processing module uses a detachable storage medium to connect point-to-point with an electronic device or a network connected to a terminal server database to download and update the cocktail recipes.

7. An automatic cocktail making method, applicable for making a plurality of delicious cocktails, comprising the steps of:
inputting water, a carbonic acid gas cylinder having carbonic acid gas and a plurality of cocktail materials;
receiving a cocktail request, and then comparing the cocktail request with a list to obtain and read the cocktail recipe corresponding to the cocktail request;
adjusting a quantity of water and the carbonic acid gas according to the cocktail recipe, mixing the water and the carbonic acid gas to form a carbonated water according to a recipe proportion of the cocktail recipe, and adjusting the carbonated water to a recipe temperature; and
adjusting a quantity of the cocktail materials according to the cocktail recipe, and then mixing the cocktail materials with the carbonated water at the recipe temperature to output the cocktail.

8. The automatic cocktail making method of claim 7, wherein the cocktail materials and the carbonated water are shaken at a predetermined shaking speed when the cocktail is mixed and outputted.

9. The automatic cocktail making method of claim 7, further comprising the following step when receiving the cocktail request:
receiving an ice-adding request to output a corresponding quantity of a plurality of ice cubes, and then shaking and mixing the cocktail materials, the carbonated water and the ice cubes to output the cocktail.

10. The automatic cocktail making method of claim 7, further comprising the step of using a detachable storage medium to connect point-to-point with an electronic device or a network connected to a terminal server database to download and update the cocktail recipes.
